(19) United States
(12) Patent Application Publication
(10) Pub. No.: US 2015/0273717 A1
(43) Pub. Date: Oct. 1, 2015

(54) SHEET HOLDER

(71) Applicant: GRAPHTEC CORPORATION, Kanagawa (JP)

(72) Inventors: Ryoichi OKA, Kanagawa (JP); Kazuhiro WATANABE, Kanagawa (JP)

(21) Appl. No.: 14/670,337

(22) Filed: Mar. 26, 2015

(30) Foreign Application Priority Data
Mar. 28, 2014 (JP) 2014-069589

(51) Int. Cl. B26D 7/01

(52) U.S. Cl. CPC B26D 7/015

(57) ABSTRACT

A sheet holder is provided in which a sheet is held without deflection in a process treatment by a plotter and the sheet is easily detached thereafter. The sheet holder is used for holding the sheet during the process treatment on the sheet, and a plurality of circular adhesive dots are applied to a sheet-shaped base material. The adhesive dots each having a predetermined diameter are arranged at predetermined intervals in a diagonal grid pattern along a sheet feeding direction. Specifically, the adhesive dots are arranged side by side along the sheet feeding direction to form adhesive dot lines. The plural adhesive dot lines are formed to be arranged side by side in a carriage moving direction. Among two adjoining adhesive dot lines, formation positions of the respective adhesive dots in one adhesive dot line and in the other adhesive dot line are different in the feeding direction.

### CROSS REFERENCE TO RELATED APPLICATION

This application is based upon and claims the benefit of priority from Japanese Patent Application No. JP 2014-069589 filed on Mar. 28, 2014, the entire contents of which are incorporated herein by reference.

### BACKGROUND OF THE INVENTION

### Field of the Invention

The present disclosure relates to a sheet holder, and particularly to a sheet holder configured to hold a sheet while a plotter is processing the sheet.

Conventionally, a plotter has been known in which a sheet mounted on a mounting table is sandwiched between each pair of drive and pressure rollers, and while the sheet is being fed by rotation of the drive rollers, a carriage on which a pen or a cutter is held operates in the direction perpendicular to the sheet feeding direction to form a predetermined image on the sheet or form a predetermined cutout on the sheet.

In the case of a relatively-thin sheet, the technique of detachably bonding, in advance, the sheet to a sheet holder serving as an underlay of the sheet in order not to bend the sheet in imaging or cutting by a plotter (see, e.g., Japanese Unexamined Patent Publication No. H05-069695 hereinafter referred to as “'695 document”).

In the pen plotter described in the '695 document, a backing sheet material is bonded to a back surface of a sheet which is an imaging-target medium, and while the sheet is being fed, a pen operates in the direction perpendicular to the sheet feeding direction. Such a configuration allows imaging on the sheet with a high pen pressure.

In this case, the backing sheet material is configured such that an adhesive is discontinuously applied in spots on a sheet base material.

For the sheet holder as described above, the bonding strength for bonding the sheet so as not to bend the sheet is required in imaging or cutting by the plotter, and on the other hand, it is required to adjust the bonding strength so that a user can easily detach the sheet after formation of a predetermined image.

Particularly in the case of a sheet formed of tissue paper, if the adhesive is applied across, e.g., the substantially entirety of an upper surface of the sheet holder, the bonding strength becomes relatively high. For such reason, when an attempt is made to detach the sheet from the sheet holder after formation of the predetermined image, a strong tension is applied to the sheet to plastically deform the sheet. Thus, there is a possibility that wrinkling or curling occurs.

Further, the concentration of the adhesive is adjusted; thereby, the bonding strength can be lowered. However, it is difficult to control the concentration of the adhesive because the bonding strength varies depending on temperature or humidity, etc.

In the sheet holder as described in the '695 document, the adhesive is discontinuously applied in spots on the sheet base material. Thus, contrivance is, to some extent, made to easily detach the sheet as compared to the case where an adhesive is applied across the entirety of an upper surface of a sheet base material. However, it is likely that the bonding strength is relatively low, considering secure holding of the sheet in imaging by the plotter.

In particular, in addition to the case of the sheet formed of tissue paper, if the plotter is a cutting plotter mainly intended to form a cutout, part of the sheet from which the cutout is formed is detached from the sheet holder, and therefore, there is a possibility that it is more likely to cause wrinkling or curling of the sheet and to easily break the sheet. Thus, it is difficult to adjust the bonding strength.

### SUMMARY OF THE INVENTION

The present disclosure is made in view of the foregoing problem, and it is intended to provide a sheet holder which holds a sheet so as not deflect the sheet in a process treatment performed by a plotter and which can easily detach the sheet while preventing the sheet from wrinkling or curling after the process treatment.

Moreover, the present disclosure is intended to provide the sheet holder which is used for a cutting plotter and which can hold the sheet while preventing a cutout from wrinkling or curling when the cutout is partially detached from tissue paper.

According to the sheet holder of the present disclosure, the foregoing problem is solved by a sheet holder used for a plotter performing a process treatment by feeding a sheet in a feeding direction intersecting with a moving direction of a carriage, which holds a pen or a cutter, while moving the carriage in a state where a tip end of the pen or the cutter is put in pressure contact with the sheet or is separated from the sheet, the sheet holder including: a sheet-shaped base material fed in the feeding direction together with the sheet in a state where the sheet is mounted on an upper surface of the base material; and a plurality of adhesive dot lines each formed of a plurality of adhesive dots which are formed on the upper surface of the base material and which are arranged side by side along the feeding direction. The plurality of adhesive dot lines are formed to be arranged side by side in the moving direction. A formation position of each of the adhesive dots forming one of two of the adhesive dot lines adjoining each other and a formation position of each of the adhesive dots forming the other of two of the adhesive dot lines adjoining each other are different in the feeding direction.

As described above, the adhesive is formed in dots on the base material. Therefore, as compared to the case where the adhesive is applied onto the entirety of the upper surface of the base material, the sheet holder holds the sheet so as not relatively deflect the sheet in the process treatment performed by the plotter, and it can easily detach the sheet after the process treatment.

Moreover, the formation position of each of the adhesive dots forming one of two of the adhesive dot lines adjoining each other and a formation position of each of the adhesive dots forming the other of two of the adhesive dot lines adjoining each other are different in the feeding direction. Therefore, as compared to, e.g., the case where the adhesive is applied in dots in an orthogonal grid pattern, the arrangement pattern can be achieved in which the pen or the cutter is more likely to overlap the adhesive dots in an up-down direction when the pen or the cutter moves in the moving direction of the carriage.

In other words, when the pen or the cutter moves along the moving direction of the carriage, the pen or the cutter easily passes (i.e., the pen or the cutter is more likely to pass) a portion where the bonding strength of the sheet is increased by the adhesive dots applied onto the sheet holder. That is, the sheet holder can hold the sheet so as not to further defect the sheet in the process treatment of the plotter.

Preferably, dot arrangement common to the one of two of the adjoining adhesive dot lines and dot arrangement common to the other of two of the adjoining adhesive dot lines are made such that the one of two of the adjoining adhesive dot lines and the other of two of the adjoining adhesive dot lines are alternately arranged at predetermined intervals in the moving direction.

According to the foregoing configuration, in part of the sheet holder on which no adhesive dots are applied and which is positioned farthest from each of the adhesive dots, the distance from each adhesive dot is short as compared to, e.g., the case where the adhesive is applied in dots in an orthogonal grid pattern.

In other words, the adhesive dots are more precisely arranged on the sheet holder at further equal intervals in a regular manner. Thus, in the process treatment of the plotter, the sheet can be held so as not to be further deflected and can be more easily detached after the process treatment.

Preferably, each of the adhesive dot line is configured so that the adhesive dots are arranged at predetermined intervals in the feeding direction, and a distance between two of the adjoining adhesive dot lines in the moving direction is shorter than a distance between the adhesive dots forming each of the adhesive dot lines in the feeding direction.

According to the foregoing configuration, as compared to, e.g., the case where the adhesive is applied in dots in an orthogonal grid pattern, the arrangement pattern can be achieved in which the pen or the cutter easily overlaps (i.e., the pen or the cutter is more likely to overlap) the adhesive dots in the up-down direction when the sheet moves in the feeding direction.

In other words, when the sheet is fed in the feeding direction, the pen or the cutter easily passes the portion where the bonding strength of the sheet is increased by the adhesive dots applied onto the sheet holder. That is, the sheet can be held so as not to be further deflected in the process treatment of the plotter.

Preferably, the one of the adjoining adhesive dot lines includes first and second dots adjacent to each other, and the other of the adjoining adhesive dot lines includes a third dot disposed between the first dot and the second dot in the feeding direction, and each of distances between the first dot and the third dot and between the second dot and the third dot is shorter than a distance between the first dot and the second dot.

For example, when the plotter processes the sheet to form an image on the sheet or cut the sheet in the direction inclined to the feeding direction, it is required that the carriage is moved while the sheet is being fed in the feeding direction. Therefore, the sheet is subjected to the largest load due to pen pressure or cutting pressure.

With the foregoing arrangement pattern of the adhesive dots, the sheet can be held so as not to be further deflected even if the sheet is subjected to the largest load due to the imaging or cutting process of the sheet in the foregoing inclined direction.

Preferably, each of the adhesive dots is formed in a circular shape, and the adhesive dots each having a predetermined diameter are arranged at predetermined intervals in a diagonal grid pattern along the feeding direction. In addition, the adhesive dots are arranged such that an inclination angle θ of an imaginary line passing the first dot and the third dot with respect to an imaginary line passing the first dot and the second dot is equal to or larger than 30° and equal to or smaller than 60°.

According to the foregoing configuration, the adhesive dots are arranged on the sheet holder at further equal intervals in a regular manner. Therefore, in the process treatment of the plotter, the sheet can be held so as not to be further deflected and can be more easily detached after the process treatment.

Preferably, the plural adhesive dots are arranged on the upper surface of the base material to form dot groups, and a surface density in the dot groups arranged at both ends of the base material in the moving direction is lower than in the dot groups arranged at a center of the base material in the moving direction.

Typically, a plotter is configured so that a sheet mounted on a mounting table is sandwiched between drive and pressure rollers and so that the sheet is fed by rotation of the drive roller. Moreover, at least a pair of pressure rollers is placed in positions corresponding to both ends of the sheet in a width direction thereof.

Therefore, if an adhesive is applied to corresponding positions on an upper surface of a sheet holder through which the pressure rollers pass, the sheet is pressed by the pressure rollers and the adhesive force between the sheet and the sheet holder increases accordingly. As a result, when the sheet is detached from the sheet holder, wrinkling or curling occurs at the sheet. Moreover, the sheet may partially adhere to the sheet holder.

On the other hand, if no adhesive is applied to the corresponding positions on the upper surface of the sheet holder through which the pressure rollers pass, the property of holding the sheet by the sheet holder may partially deteriorate, therefore affecting finished quality after a process treatment.

Accordingly, as in the sheet holder having the foregoing configuration, the surface density of the adhesive dots is adjusted at the both ends and center of the upper surface of the base material; thereby, the bonding strength of the adhesive can be adjusted. That is, the bonding strength can be set low at the both ends of the upper surface of the base material through which the pressure rollers may pass. As a result, the property of holding the sheet can be ensured and wrinkling or curling of the sheet due to pressing by the pressure rollers can be restricted.

Preferably, the plotter configured by a cutting plotter is used while the process treatment is performed on the sheet formed of tissue paper.

As described above, if the plotter is the cutting plotter mainly intended to form a cutout, the cut out which is a part of the sheet is detached from the sheet holder; therefore, there is a possibility that it is more likely to cause wrinkling or curling of the sheet to easily break the sheet. Thus, the effect of the sheet holder of the present disclosure is marked.

Moreover, in the case of the sheet formed of tissue paper, when an attempt is made to detach the sheet from the sheet holder after the process treatment of the plotter, the possibility of a plastic deformation of the sheet and wrinkling or curling of the sheet increases. Therefore, the effect of the sheet holder of the present disclosure is further significant.

### BRIEF DESCRIPTION OF THE DRAWINGS

FIG. 1 is an external perspective view of a plotter including a sheet holder according to an embodiment of the present disclosure.

FIG. 2 is a plan view of the sheet holder.

FIG. 3 is a cross-sectional view of the sheet holder along the line III-III.

FIG. 4 is an enlarged plan view of a main part of the sheet holder.

FIG. 5 is a view illustrating the state in which a predetermined cutout is detached from an upper surface of the sheet holder.

FIG. 6 is a plan view of a sheet holder of a second embodiment.

FIG. 7 is a plan view of a sheet holder of a third embodiment.

FIG. 8 is a plan view of a sheet holder of a fourth embodiment.

### DETAILED DESCRIPTION

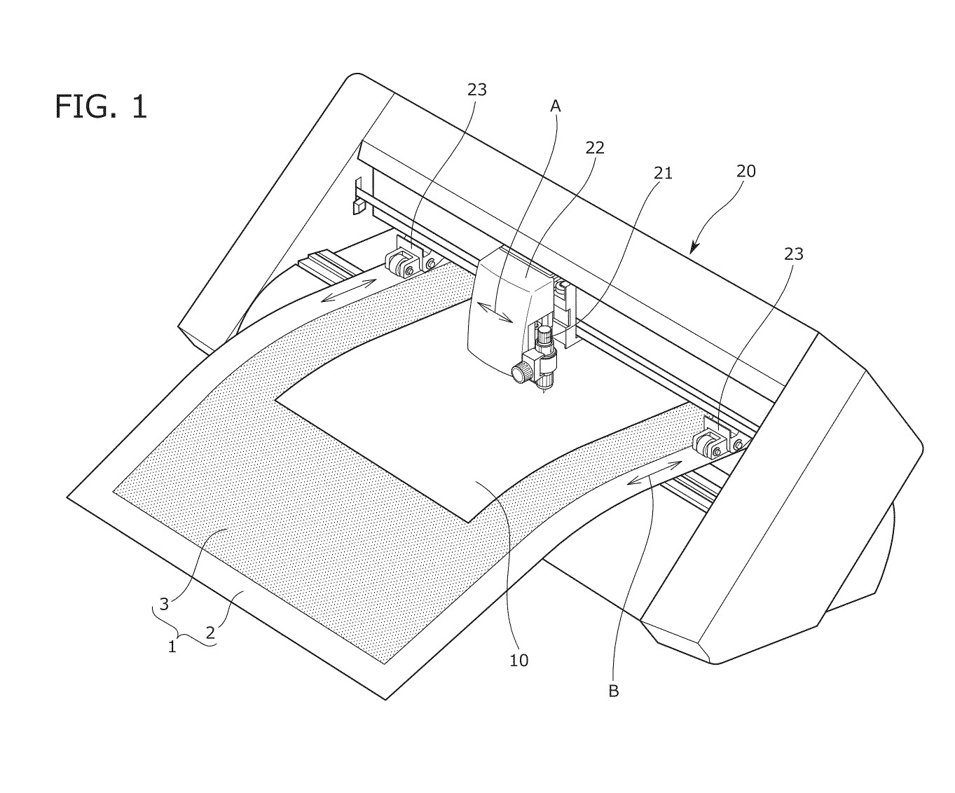

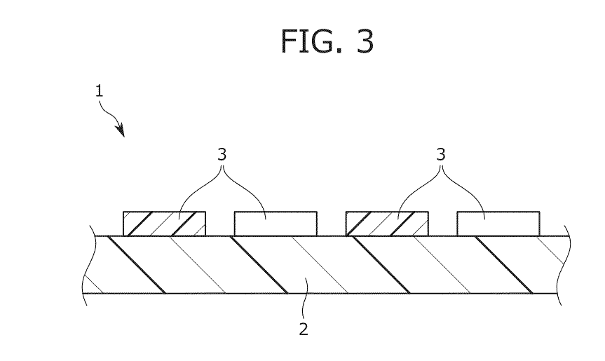

Embodiments of the present disclosure will be described below with reference to FIGS. 1 to 8.

The present embodiment relates to a sheet holder used while a plotter is processing a sheet. The sheet holder is configured such that an adhesive is applied in substantially-circular dots on an upper surface of a sheet-shaped base material and that the adhesive dots each having a predetermined diameter are arranged in a diagonal grid pattern at predetermined intervals along a sheet feeding direction (feeding direction).

Further, in FIGS. 1 to 8, the direction of moving a carriage in the plotter corresponds to the direction indicated by “A,” and the sheet feeding direction corresponds to the direction indicated by “B.”

A sheet holder 1 of the present embodiment is, as illustrated in FIG. 1, used as an underlay of a sheet 10 while a plotter 20 is processing the sheet 10.

The sheet 10 is formed of tissue paper and is specifically formed of a relatively-thin non-elastic material such as tracing paper.

Further, the sheet 10 is not limited to tissue paper, but may be formed of, e.g., relatively-thick paper or synthetic paper, a pattern for clothes, a stencil or mask pattern for decorations, a greeting card, craft paper, a film, or cloth.

The plotter 20 is configured to perform a process treatment as follows. The plotter 20 feeds the sheet 10 in a feeding direction B intersecting with a moving direction A of a carriage 22, which holds a cutter 21, while moving the carriage 22 in a state where a tip end of the cutter 21 is selectively put in contact with the sheet 10 under pressure (pressure contact) or is separated from the sheet 10. The plotter 20 corresponds to a cutting plotter.

Further, the plotter 20 may be optionally changed to a plotter other than the cutting plotter configured to form a predetermined cutout on the sheet 10. For example, the plotter 20 may be a pen plotter configured to form a predetermined image on the sheet 10 with a pen held by the carriage 22 instead of the cutter 21.

As illustrated in FIGS. 1 to 3, the sheet holder 1 includes a sheet-shaped base material 2 fed in the feeding direction B together with the sheet 10 in a state where the sheet 10 is mounted on an upper surface of the sheet holder 1, and plural dots 3 applied onto the base material 2 and formed of an adhesive.

The base material 2 is formed of a substantially-rectangular elongated plastic sheet, and is specifically formed of a polyethylene terephthalate film having a thickness of about 0.1 to 0.3 mm.

Further, in addition to the polyethylene terephthalate film, e.g., a polycarbonate film, a paperboard for paper container, a white paperboard, or a special paperboard may be applied to the base material 2.

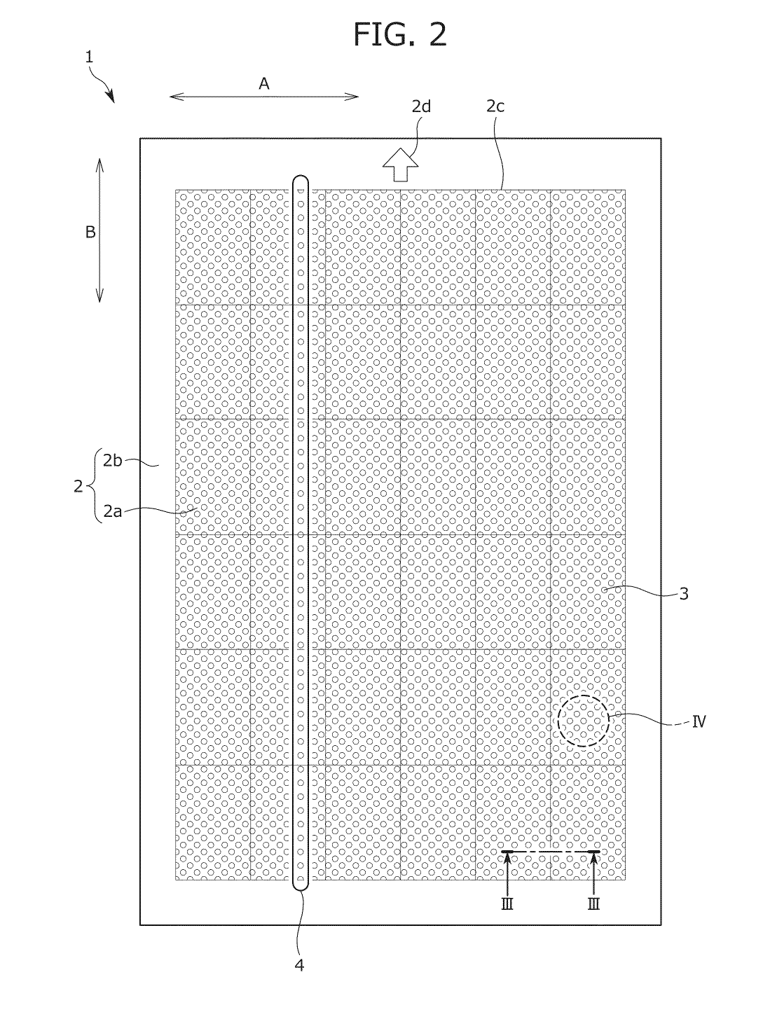

As illustrated in FIG. 2, an upper surface of the base material 2 has an adhesive applied region 2a surrounded by frame borders arranged at predetermined intervals at the inner side of the outer circumferential edge of the base material 2, and a frame-shaped adhesive non-applied region 2b formed on the outer side of the adhesive applied region 2a.

Grid lines 2c serving as reference lines for bonding the sheet 10 to a predetermined position are printed on the adhesive applied region 2a along the sheet feeding direction B and the carriage moving direction A.

An arrow mark 2d indicating the setting direction of the sheet 10 is printed at one end part of the adhesive non-applied region 2b in the sheet feeding direction B.

Further, both end parts of the adhesive non-applied region 2b in the sheet width direction correspond to portions which respectively contact pressure rollers 23 of the plotter 20 illustrated in FIG. 1.

As illustrated in FIG. 2, the adhesive dots 3 are substantially-circular dots, and are applied across the entirety of the adhesive applied region 2a of the upper surface of the base material 2.

Note that the adhesive may have such a degree of bonding strength that the sheet 10 is detachably bonded, and the type of adhesive is not limited. Furthermore, in order to apply the adhesive dots 3 in a predetermined arrangement pattern, for example, the adhesive is sprayed onto a perforated sheet (not shown) overlaid on the upper surface of the base material 2; thereby, the adhesive dots 3 are applied to predetermined positions on the upper surface of the base material 2, for example.

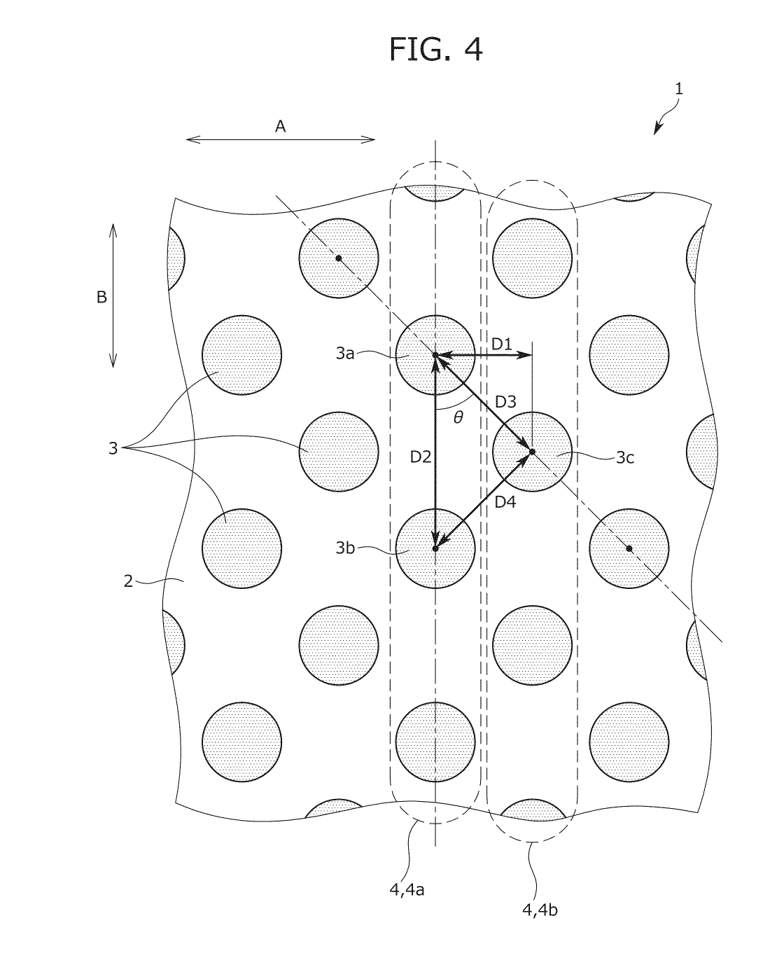

As illustrated in FIGS. 2 and 4, the adhesive dots 3 each having a predetermined diameter are arranged at predetermined intervals (pitches) in a diagonal grid pattern along the sheet feeding direction B.

In terms of specific numerical values, the surface density of the adhesive dots 3 on the adhesive applied region 2a on the upper surface of the base material 2 is preferably about 35% to 45%, and the surface density is adjusted by the diameter of each adhesive dot 3 and the distance (pitch) between the adhesive dots 3. For example, supposing that the diameter of each adhesive dot 3 illustrated in FIG. 4 is about 0.9 mm and that the distance (pitch) D2 between the adhesive dots 3 is about 1.83 mm, the surface density is about 38%.

The lower limit of the surface density of the adhesive dots 3 is set at about 35%; thereby the bonding strength to the sheet 10 in the process treatment performed by the plotter 20 can be ensured. For example, even if the sheet holder 1 is partially or entirely inclined in the process treatment, the possibility of turning up of the sheet 10 is reduced, for example.

Moreover, the upper limit of the surface density of the adhesive dots 3 is set at about 45%; thereby, after the process treatment, the sheet 10 can be easily detached without wrinkling or curling.

In addition, the surface density of the adhesive dots 3 is not limited to the foregoing range and may be optionally changed depending on the type of adhesive.

Next, the arrangement pattern of the adhesive dots 3 will be described in detail with reference to FIG. 4.

The plural adhesive dots 3 are arranged in the sheet feeding direction B, thereby forming adhesive dot lines 4. The plural adhesive dot lines 4 are formed to be arranged in the carriage moving direction A.

In such a state, two adjoining dot lines 4a, 4b of the adhesive dot lines 4 are arranged such that the formation position of each adhesive dot 3 forming the dot line 4a and the formation position of each adhesive dot 3 forming the dot line 4b are different from each other in the sheet feeding direction B.

In addition, arrangement of the adhesive dots 3 common to the dot lines 4a and arrangement of the adhesive dots 3 common to the dot lines 4b form such a pattern that the dot lines 4a, 4b are alternately arranged at predetermined intervals in the carriage moving direction A.

The distance D1 between the adjoining dot lines 4a, 4b of the adhesive dot lines 4 in the carriage moving direction A is shorter than the distance D2 between the adhesive dots 3 each forming the adhesive dot line 4 in the sheet feeding direction B.

Further, as illustrated in FIG. 4, it is assumed that the two adjoining adhesive dots 3 of the dot line 4a are a first dot 3a and a second dot 3b and that the adhesive dot 3 of the dot line 4b, which is disposed between the first dot 3a and the second dot 3b in the sheet feeding direction B is a third dot 3c.

In this case, each of the distance D3 connecting between the first dot 3a and the third dot 3c and the distance D4 connecting between the second dot 3b and the third dot 3c is shorter than the distance D2 connecting between the first dot 3a and the second dot 3b.

Furthermore, as illustrated in FIG. 4, when an inclination angle of an imaginary line passing the first dot 3a and the third dot 3c with respect to an imaginary line passing the first dot 3a and the second dot 3b is defined as “θ”, the inclination angle θ is set at about 45°.

In accordance with the setting above, each of the distance D3 and the distance D4 is shorter than the distance D2. That is, the distance between the adhesive dots 3 in the inclination direction is shorter than the distance between the adhesive dots 3 in the sheet feeding direction B.

Therefore, when the plotter 20 performs a process of cutting the sheet 10 in the direction inclined to the sheet feeding direction B, the sheet holder 1 can hold the sheet 10 so as not to further deflect the sheet 10.

Typically, when the plotter 20 performs the process of cutting the sheet 10 in the direction inclined to the sheet feeding direction B, it is required that the carriage 22 is moved while the sheet 10 is being fed in the sheet feeding direction B. Thus, the sheet 10 is subjected to the largest load due to cutting pressure. Therefore, the arrangement pattern of the adhesive dots 3 is significant in ensuring the force for holding the sheet 10.

In addition, the inclination angle θ is preferably set at an angle of equal to or larger than about 30° and equal to or smaller than about 60°. Is the inclination angle θ is set in this way, each of the distance D3 and the distance D4 is shorter than or equal to the distance D2. Thus, the above-mentioned arrangement pattern of the adhesive dots 3 can be achieved.

In the foregoing configuration, the sheet holder 1 is configured so that the adhesive is applied in dots onto the base material 2. Therefore, as compared to the case where the adhesive is applied onto the entirety of the upper surface of the base material 2, the sheet holder 1 holds the sheet 10 so as not to further deflect the sheet 10 in the process treatment performed by the plotter 20, and it can easily detach the sheet 10 after the process treatment.

Moreover, the sheet holder 1 is configured so that the adhesive are arranged on the base material 2 in the diagonal grid pattern along the sheet feeding direction B of. Therefore, as compared to the case where the adhesive are applied in dots of e.g., an orthogonal grid pattern, the adhesive dots 3 are arranged at further equal intervals in a regular manner. Consequently, the sheet 10 can be held so as not to be further deflected in the process treatment performed by the plotter 20, and the sheet 10 can be more easily detached after the process treatment.

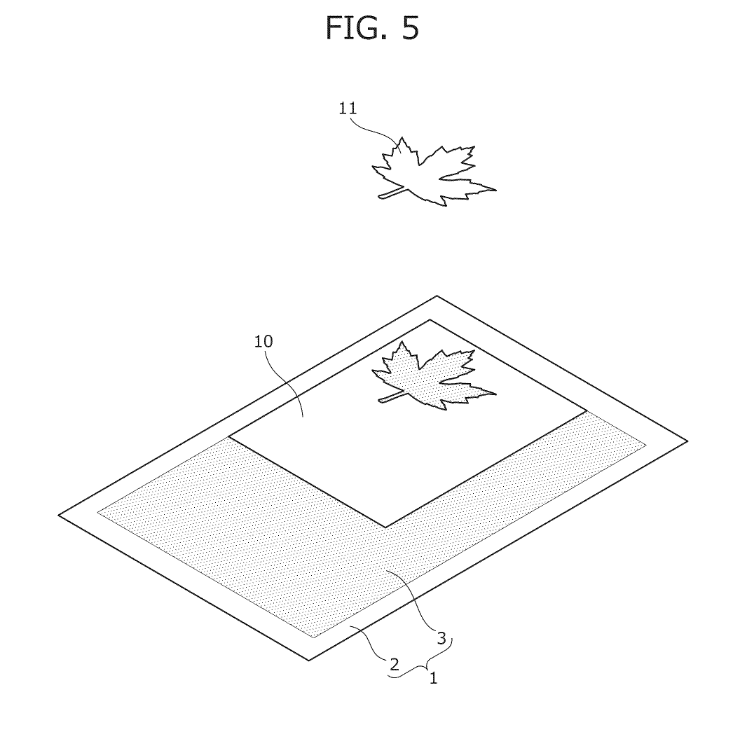

Additionally, as described above, the sheet holder 1 is configured so that the adhesive dots 3 are arranged at equal intervals in a regular manner. Therefore, as illustrated in FIG. 5, even in the case where a relatively-complicated cutout 11 forming part of tissue paper is detached after the process treatment performed by the cutting plotter, the occurrence of wrinkling or curling of the cutout 11 can be reduced, and the tissue paper can be held so as not to tear.

Moreover, as illustrated in FIG. 2, the sheet holder 1 is configured so that some of the plural adhesive dots 3 are applied to partially overlap the borderline between the adhesive applied region 2a and the adhesive non-applied region 2b. Therefore, even in the case where the sheet 10 is bonded to a position close to the borderline as illustrated in FIG. 5, the sheet 10 can be held so as not to be deflected in the process treatment performed by the plotter 20.

### Second Embodiment of Sheet Holder

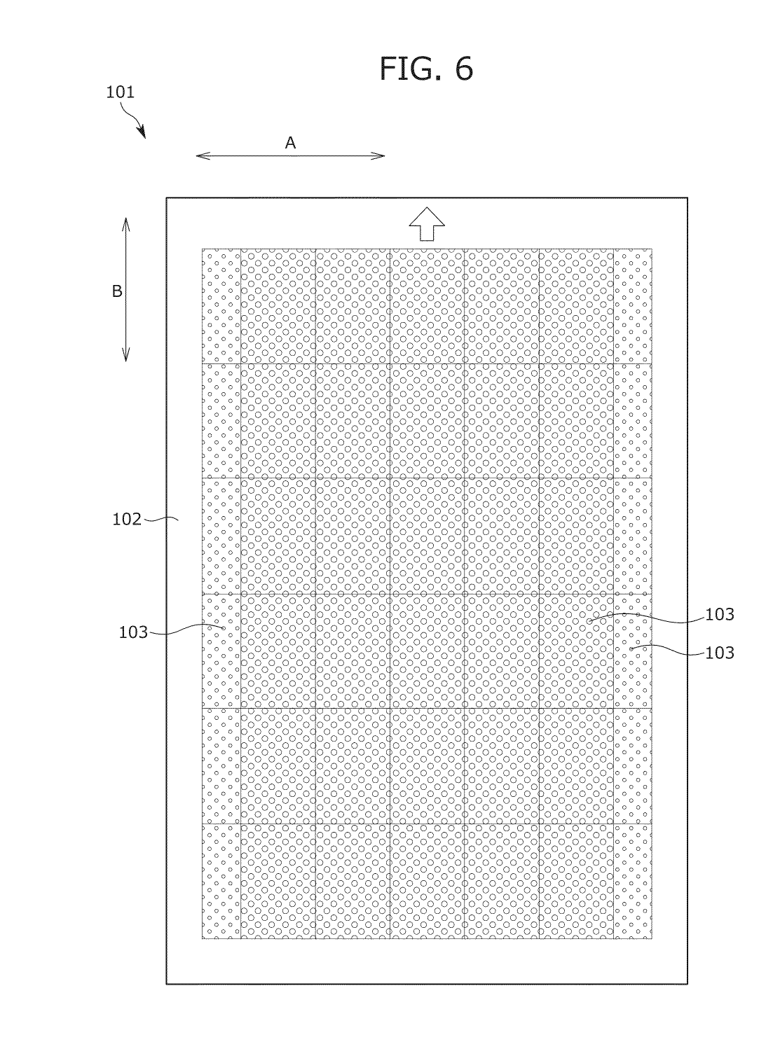

Next, a second embodiment of the sheet holder 1 will be described with reference to FIG. 6.

In addition, the details overlapped with the foregoing description of the sheet holder 1 will be omitted.

A sheet holder 101 according to the second embodiment is different from the sheet holder 1 in the configuration in which groups of adhesive dots 103 arranged on an upper surface of a base material 102 are configured so that the surface density is partially different.

Specifically, as illustrated in FIG. 6, the groups of adhesive dots 103 arranged at both ends of the base material 102 in a width direction thereof are formed to have the surface density lower than that of the groups of adhesive dots 103 disposed at the center of the base material 102.

More specifically, the groups of adhesive dots 103 arranged at the both ends of the base material 102 in the width direction are configured so that the diameter of each adhesive dot 103 is smaller than that of each adhesive dot 103 in the groups of adhesive dots 103 disposed at the center of the base material 102.

Further, the distance between the adhesive dots 103 is adjusted instead of adjusting the diameter of each adhesive dot 103; thereby, the surface density may be adjusted.

Parts of the base material 102, which are at the both ends of the base material 102 in the width direction and which are provided with the groups of adhesive dots 103 correspond to portions in which the sheet 10 may contact the pressure rollers 23 of the plotter 20 illustrated in FIG. 1. The parts of the base material 102 correspond to portions in which the sheet 10 may be sandwiched between the pressure rollers 23 and the sheet holder 101, depending on the case where the sheet 10 is large in size or depending on arrangement of the sheet 10.

In the meantime, as is conventionally done, if the adhesive is applied to portions in which the pressure rollers 23 pass on an upper surface of the sheet holder 101, the sheet 10 is pressed by the pressure rollers 23, and the adhesive force between the sheet 10 and the sheet holder 101 increases accordingly. As a result, when the sheet 10 is detached from the sheet holder 101, wrinkling or curling occurs at the sheet 10. Moreover, a part of the sheet 10 may adhere to the sheet holder 101.

On the other hand, if no adhesive is applied to the positions in which the pressure rollers 23 pass on the upper surface of the sheet holder 101, the property of holding the sheet 10 by the sheet holder 101 partially deteriorates. As a result, finished quality after the process treatment may deteriorate.

Accordingly, in the present embodiment, the surface density of the adhesive dots 103 is adjusted at the both ends and at the center of the upper surface of the base material 102 in the width direction; thereby, the bonding strength of the adhesive can be adjusted. Specifically, at the both ends of the upper surface of the base material 102 in the width direction, the pressure rollers 23 may pass and the sheet 10 may be sandwiched between the pressure roller 23 and the sheet holder 101. At such ends of the base material 102, the bonding strength can be set low. As a result, the sheet holder 101 is configured to ensure the property of holding the sheet 10 and to reduce the occurrence of wrinkling or curling of the sheet 10 due to a pressing force by the pressure rollers 23.

### Third Embodiment of Sheet Holder

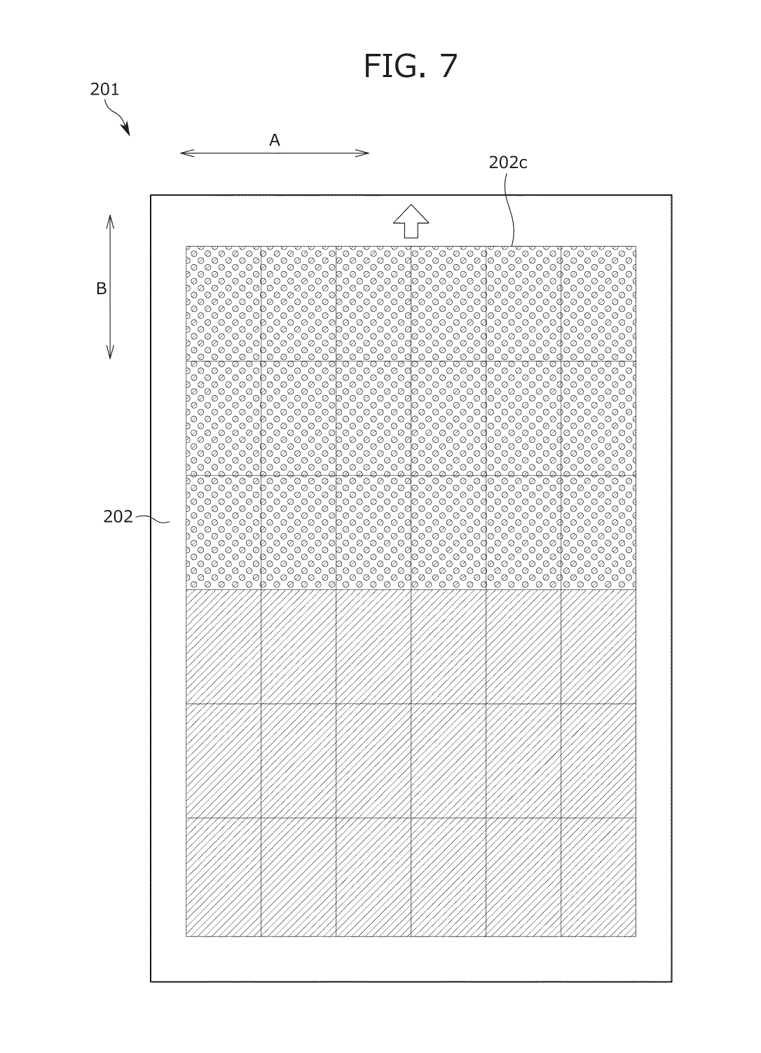

Next, a third embodiment of the sheet holder 1 will be described with reference to FIG. 7.

A sheet holder 201 according to the third embodiment is different from the sheet holder 1 in the configuration in which a region where an adhesive is applied in dots and a region where the adhesive is applied to a substantially-entire surface are provided on an upper surface of a base material 202.

Specifically, as illustrated in FIG. 7, the adhesive is applied in dots at one end of the upper surface of the base material 202 in the sheet feeding direction B, whereas the adhesive is applied to the substantially-entire surface at the other end of the upper surface of the base material 202 in the sheet feeding direction B.

Moreover, borders of the adhesive applied regions are formed along grid lines 202c.

According to the foregoing configuration, the sheet holder 201 can hold the sheet 10 with a desired bonding strength by adjusting a position of the sheet 10 to be bonded onto the sheet holder 201 depending on the type of sheet 10.

### Fourth Embodiment of Sheet Holder

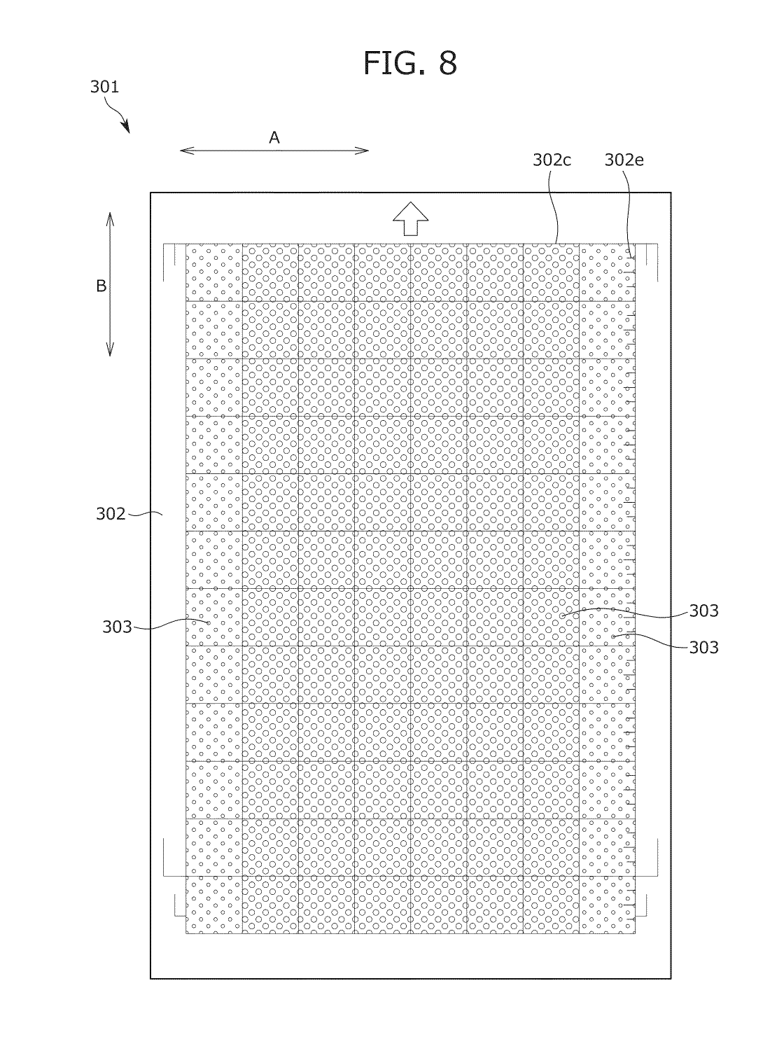

Next, a fourth embodiment of the sheet holder 1 will be described with reference to FIG. 8.

As in the sheet holder 101 of the second embodiment, a sheet holder 301 according to the fourth embodiment is configured such that groups of adhesive dots 303 arranged at both ends of a base material 302 in a width direction thereof to have the surface density lower than in groups of adhesive dots 303 disposed at the center of the base material 302.

Specifically, the diameter of each adhesive dot 303 in the groups of adhesive dots 303 at the both ends of the base material 302 is smaller than the diameter of each adhesive dot 303 in the groups of adhesive dots 303 at the center of the base material 302, and the distance between the adhesive dots 303 in the groups of adhesive dots 303 at the both ends of the base material 302 is larger than the distance between the adhesive dots 303 in the groups of adhesive dots 303 at the center of the base material 302.

Grid lines 302c for bonding the sheet 10 to a predetermined position are printed on an adhesive applied region 302a of the sheet holder 301 along the sheet feeding direction B and the carriage moving direction A. Moreover, predetermined scale marks 302e are printed along the sheet feeding direction B.

### Other Embodiments

In the foregoing embodiments, the adhesive dots 3 are formed in a substantially-circular shape as illustrated in FIGS. 2 and 4; however, they are not limited to such a configuration. The adhesive dots 3 may be formed in a substantially-oval shape, a substantially-rectangular shape, or a substantially-polygonal shape, etc.

Further, in the foregoing embodiments, as illustrated in FIG. 4, each dot arrangement of the dot lines 4a and each dot arrangement of the dot lines 4b form such a pattern that the dot lines 4a, 4b are alternately arranged along the carriage moving direction A. However, such arrangement pattern may be optionally changed.

For example, the dot lines 4a in two rows and the dot lines 4b in two rows may be alternately arranged side by side. Alternatively, the dot lines 4a may be arranged at one end of the sheet holder 1 in the width direction, and the dot lines 4b may be arranged at the other end of the sheet holder 1 in the width direction.

The adhesive dot lines 4 are not necessarily arranged at equal intervals in the carriage moving direction A.

Moreover, in the foregoing embodiments, as illustrated in FIG. 4, the adhesive dot lines 4 are formed such that the adhesive dots 3 are arranged at predetermined intervals in the sheet feeding direction B; however, they are not limited to such a configuration. The adhesive dots 3 are not necessarily arranged at equal intervals.

Further, in the foregoing embodiments, as illustrated in FIG. 1, the plotter 20 is configured such that the sheet feeding direction B and the carriage moving direction A are perpendicular to each other; however, it may be configured such that the sheet feeding direction B and the carriage moving direction A intersect each other.

In addition, in the foregoing embodiments, as illustrated in FIG. 1, the plotter 20 is configured such that the cutter 21 is held by the carriage 22. However, the plotter 20 may be configured such that both of the cutter 21 and a pen are held by the carriage 22, thereby having both functions of the cutter and the pen.

In the present embodiment, the sheet holder according to the present disclosure is mainly described. However, the foregoing embodiments are merely examples for the sake of easy understanding of the present disclosure, and they do not limit the present disclosure. Changes and modifications may be made to the present disclosure without departing from the spirit thereof, and obviously, the present disclosure may include all equivalents.

In particular, the arrangement pattern of the adhesive dots of the sheet holder described in the foregoing embodiments is merely an example, and they do not limit the present disclosure.

### REFERENCE NUMERALS

1, 101, 201, 301 sheet holder
2, 102, 202, 302 base material
2a, 302a adhesive applied region
2b adhesive non-applied region
2c, 202c, 302c grid lines
2d arrow mark
302e scale marks
3, 103, 303 adhesive dots
3a first dot
3b second dot
3c third dot
4 adhesive dot lines
4a dot line
4b dot line
10 sheet
11 cutout
20 plotter
21 cutter
22 carriage
23 pressure rollers
A carriage moving direction
B sheet feeding direction
D1, D2, D3, D4 distance (interval)
θ inclination angle

What is claimed is:

1. A sheet holder used for a plotter performing a process treatment by feeding a sheet in a feeding direction intersecting with a moving direction of a carriage, which holds a pen or a cutter, while moving the carriage in a state where a tip end of the pen or the cutter is put in pressure contact with the sheet or is separated from the sheet, the sheet holder comprising:
a sheet-shaped base material fed in the feeding direction together with the sheet in a state where the sheet is mounted on an upper surface of the base material; and
a plurality of adhesive dot lines each formed of a plurality of adhesive dots which are formed on the upper surface of the base material and which are arranged side by side along the feeding direction,
wherein the plurality of adhesive dot lines are formed to be arranged side by side in the moving direction, and
wherein a formation position of each of the adhesive dots forming one of two of the adhesive dot lines adjoining each other and a formation position of each of the adhesive dots forming an other of two of the adhesive dot lines adjoining each other are not aligned in the feeding direction.

2. The sheet holder according to claim 1, wherein dot arrangement common to the one of two of the adjoining adhesive dot lines and dot arrangement common to the other of two of the adjoining adhesive dot lines are made such that the one of two of the adjoining adhesive dot lines and the other of two of the adjoining adhesive dot lines are alternately arranged at predetermined intervals in the moving direction.

3. The sheet holder according to claim 2, wherein each of the adhesive dot line is configured so that the adhesive dots are arranged at predetermined intervals in the feeding direction, and
wherein a distance between two of the adjoining adhesive dot lines in the moving direction is shorter than a distance between the adhesive dots forming each of the adhesive dot lines in the feeding direction.

4. The sheet holder according to claim 1, wherein the one of the adjoining adhesive dot lines includes first and second dots adjacent to each other, and the other of the adjoining adhesive dot lines includes a third dot disposed between the first dot and the second dot in the feeding direction, and
wherein each of distances between the first dot and the third dot and between the second dot and the third dot is shorter than a distance between the first dot and the second dot.

5. The sheet holder according to claim 4, wherein each of the adhesive dots is formed in a circular shape, and the adhesive dots each having a predetermined diameter are arranged at predetermined intervals in a diagonal grid pattern along the feeding direction, and
wherein the adhesive dots are arranged such that an inclination angle θ of an imaginary line passing the first dot and the third dot with respect to an imaginary line passing the first dot and the second dot is equal to or larger than 30° and equal to or smaller than 60°.

6. The sheet holder according to claim 1, wherein the plurality of adhesive dots are arranged on the upper surface of the base material to form dot groups, and
wherein a surface density in the dot groups arranged at both ends of the base material in the moving direction is lower than in the dot groups arranged at a center of the base material in the moving direction.

7. The sheet holder according to claim 1, wherein the plotter configured by a cutting plotter is used while the process treatment is performed on the sheet formed of tissue paper.
